(19) United States
(12) Patent Application Publication
(10) Pub. No.: US 2005/0235715 A1
(43) Pub. Date: Oct. 27, 2005

(54) Cattle waste composting

(76) Inventors: Alice A. Devine, Topeka, KS (US); Kylo M. Heller, McFarland, KS (US)

Correspondence Address: BLACK LOWE & GRAHAM, PLLC, 701 FIFTH AVENUE, SUITE 4800, SEATTLE, WA, 98104, US

(21) Appl. No.: 10/830,873

(22) Filed: Apr. 23, 2004

(51) Int. Cl. C05F 11/08

(52) U.S. Cl. 71/6

(57) ABSTRACT

The disclosure provides a method of composting cattle waste comprising the steps of forming a windrow of beef cattle manure, adding moisture to the windrow, monitoring the temperature of the windrow, maintaining the moisture content of the windrow and mixing the windrow after a predetermined temperature drop. The windrow is formed in an outdoor environment, preferably without a carbon amendment. During active composting, the moisture content of the organic portion of the windrow is kept within a range of 40% to 65% by weight. Steps of monitoring the temperature, addition moisture, and mixing are repeated until such steps do not create a predetermined significant temperature increase following the step of mixing. The manure is cured and analyzed as final steps in the process before packaging and shipping.

### FIELD OF THE INVENTION

This invention relates generally to methods of composting animal waste products and, more specifically, to large-scale composting of beef cattle waste.

### BACKGROUND OF THE INVENTION

Cattle feedlots are widely used to efficiently raise high quality beef cattle. Cattle manure is a by-product of the cattle feeding industry that must be disposed of routinely. Manure can provide a good soil enhancement, but has drawbacks that often make it undesirable to crop producers. The most common problems associated with manure as an organic based nutrient source are weed seed content, lack of uniformity, and costly transportation. For these reasons, manure may be considered a liability rather than an asset.

Composting is a microbial process that has been utilized for hundreds of years to decompose various types of organic wastes. Composting large quantities of cattle manure has been a difficult and imprecise endeavor. Typically, manure composting piles are formed after which moisture and carbon amendments are added. Carbon, usually in the form of straw, is added to maintain a carbon-to-nitrogen ratio generally from 25:1 to 30:1. The high carbon ratio provides a favorable microbial environment for composting. However, the carbon amendments also increase the initial volume of the compost pile, decreasing the density and, thus, the amount of cattle manure composted in the pile.

Moisture is also important for microbial action. Moisture levels in the range of 40 to 60 percent are thought to be ideal for composting. However, such levels can be difficult to maintain, especially if a large quantity of straw or other carbon amendment is added. The straw increases the available oxygen for composting but also increases the rate of moisture loss from the pile. Compost that is moisture dense is also heavy and expensive to transport.

According to current methods, the compost piles are turned or mixed on a regular, time-interval basis. For example the piles may be turned biweekly. The pile turning can improve the microbial environment by redistributing the different particle sizes to increase passive air infiltration, and by redistributing the moisture. However, interval pile turning is blind. The composting manure may be experiencing good microbial activity, or such activity may have long since diminished. Thus, resources, such as time and equipment, can be unnecessarily wasted or the composting process unnecessarily delayed using current methods.

A simplified, more effective method of composting cattle manure would be advantageous to increase the value of the large amount of manure requiring removal. The need exists for a more consistent soil enhancement product from a large scale operation that is nutrient rich, uniform, substantially devoid of weed seeds, and easier to transport. The reduction of the costs of composting by minimizing the required man-hours tending to the process of adding moisture and carbon, and turning is also desirable.

### SUMMARY OF THE INVENTION

The present invention comprises a method of composting cattle waste. The steps include forming a pile of waste in an outdoor environment, monitoring the temperature of the pile, monitoring the moisture content of the pile, mixing the pile, and adding moisture as needed. The pile is mixed after a predetermined temperature drop is sensed. Adding moisture to the pile is carried out as needed to maintain the moisture content within a predetermined range. The steps of monitoring the temperature and moisture, adding moisture, and mixing are repeated until such steps do not create a significant temperature increase following the step of mixing.

In accordance with further preferred aspects of the invention, the method further includes the step of bringing the pile to a predetermined moisture level and mixing the pile after the step of forming the pile and before the step of monitoring the temperature of the pile.

In accordance with one preferred aspect of the invention, the pile is cured and mixed after prior steps do not create a significant temperature increase. A further step includes analyzing samples of the pile to determine pile nutrient moisture, and weed seed content.

Preferably, the step of bringing the pile to predetermined moisture level includes the bringing the moisture content of the pile within the range of 40% to 65% moisture, on a weight basis.

In accordance with yet another preferred aspect of the invention, the waste includes cattle manure. The waste may also include the cattle carcasses. Such a waste pile is formed into at least one windrow. The initial height of the windrow is at least three feet and the width is at least eight feet. Preferably, the step of mixing the windrow is accomplished with a mixer.

In accordance with a further preferred aspect of the invention, a significant carbon amendment is not added to the pile.

In another preferred aspect of the invention, the added moisture is obtained at least partially from pile effluent.

Yet other preferred aspects of the invention include monitoring the temperature at least weekly and monitoring the oxygen level.

In accordance with another preferred aspect of the invention, a soil enhancement is produced by a process including the steps of collecting cattle waste, forming the cattle waste into at least one pile, bringing the moisture level of the pile to within a predetermined range, monitoring the temperature of the pile, and mixing the pile upon a predetermined temperature drop. The steps of monitoring and mixing are repeated until the mixing results in no significant temperature increase.

In accordance with such preferred aspects of the invention, the process further includes the step of checking the moisture content of the pile after a predetermined temperature drop. Moisture is added to the pile as needed to bring the moisture content within a predetermined range. The process may further include a step of curing the waste after mixing results in no significant temperature increase.

As may be appreciated from the foregoing summary and the following description, the process efficiently provides a soil enhancement product through increased temperature monitoring and decreased labor input so as to minimize the time period necessary to create the compost while also minimizing the cost involved. The organic based nutrient source produced also includes good nutrient levels, is easy to transport, and has minimal amounts of undesirable elements, such as weed seeds.

### BRIEF DESCRIPTION OF THE DRAWINGS

The preferred and alternative embodiments of the present invention are described in detail below with reference to the following drawings.

FIG. 1 is a flowchart summarizing the basic processes of the invention used to create soil enhancement from cattle waste;

FIG. 2 is an illustration of the step of forming a windrow with manure being dumped from a truck;

FIG. 3 illustrates one preferred example of adding moisture to the windrow;

FIG. 4 illustrates one method of turning and mixing the manure and the windrow; and

FIG. 5 is a graph of temperature versus time for a sample process.

### DETAILED DESCRIPTION OF THE PREFERRED EMBODIMENT

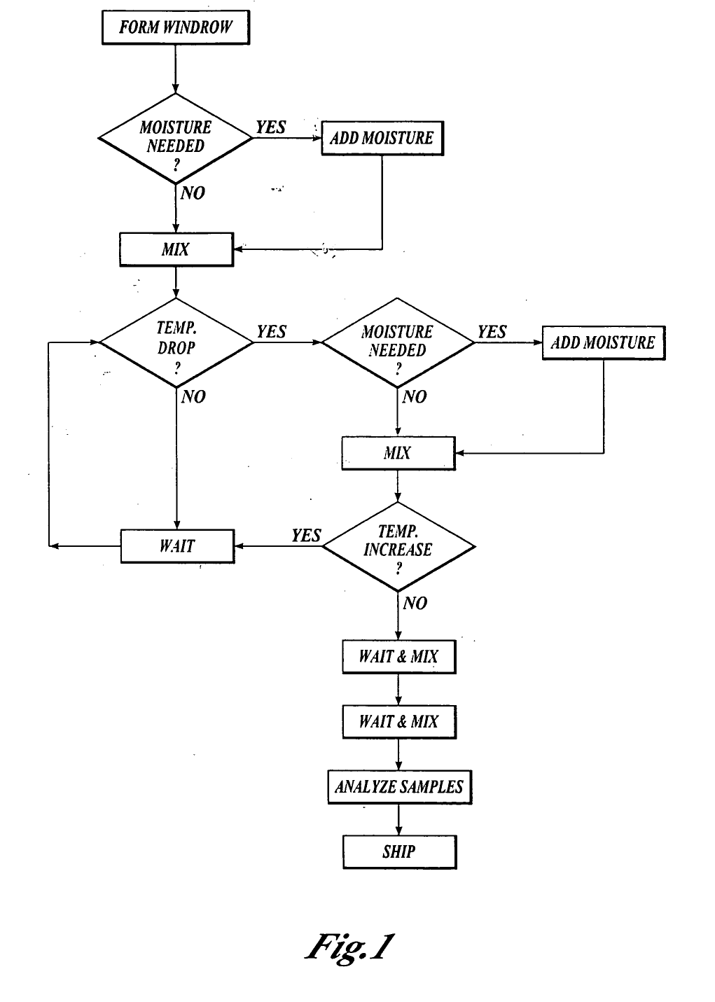

The preferred processes and product of the present invention will now be described in detail with reference to the figures. Referring first to FIG. 1, a flowchart of the basic processes of the invention is illustrated. The first step of the process is to form a windrow from feedlot manure. The windrow is an elongated pile most preferably formed approximately four feet high and twelve to fourteen feet wide on bare ground by dumping the animal waste material with a dump truck. The windrow size is preferably at least eight feet wide and three feet high. The animal waste material may include manure, animal carcasses, and some amount of dirt or sand that may be included with the animal waste products when removing them from the feedlot area. Other amendments to the manure may be added. However, in the preferred embodiment of the invention, carbon amendments are not added, contrary to the common practice of mixing straw or other carbon sources into a compost pile.

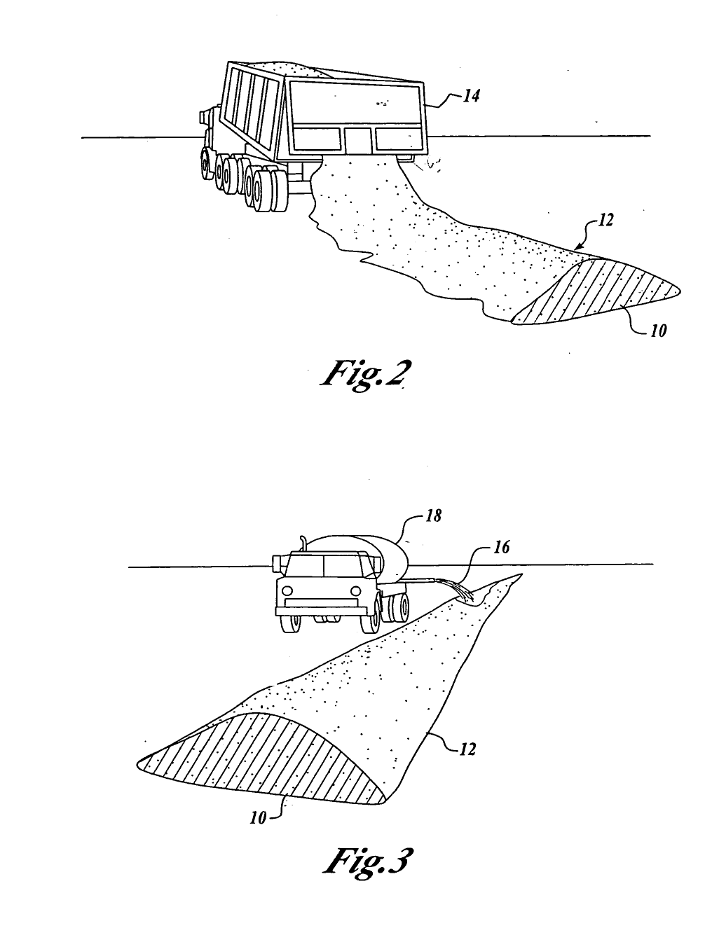

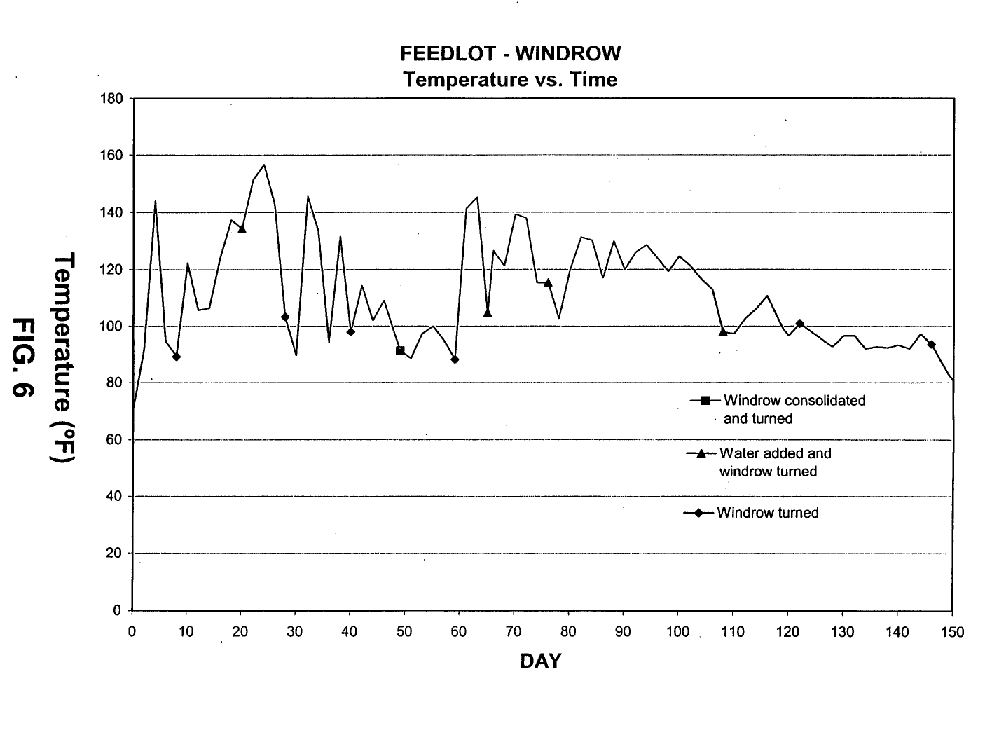

Referring to FIG. 2, manure 10 is formed into a windrow 12 with the help of a dump truck 14. A tractor, such as tractor 20 illustrated in FIG. 4, may also be used to form the windrow. Other equipment, such as graters or mixers (see FIG. 5) may also be used to aid in the proper formation of windrow 12 from the animal waste such as manure 10. Some flexibility here allows for equipment that would be available in the particular operation. For example, a front-end loader may be available equipment in a cattle feedlot operation and, thus, can be used to form the windrow. The length of the windrow simply depends on the space allotted. Multiple rows of windrows may be used depending on the space and amount of animal waste to be composted. The distance between the rows of windrows should be such as to accommodate the equipment that will be used in the process of forming the windrows and maintaining and turning the windrows as described below and illustrated in FIG. 4.

After windrow 12 is formed, the moisture content of the animal waste is checked and moisture is added such that a preferred initial moisture content by weight of the organic matter fraction of the waste is between 40% to 65%. The moisture content is assessed by obtaining a representative sample of the animal waste or manure 10 and weighing the sample before and after moisture removal. Moisture removal may be accomplished through heating the sample, such as in a microwave. The moisture content of the organic matter is determined using the following equation:
0.40 a/[(c)(b)+a] 0.65
where a is the percent moisture, b is the percent organic matter on a dry matter basis, and c is the percent solids. All percentages are on a weight basis. Most feedlot pen manure, will only be 20% to 40% moisture, as a whole, when the organic matter fraction is at 40-65% moisture. This moisture level contrasts with prior composting methods that recommend an overall moisture content between 40-65%.

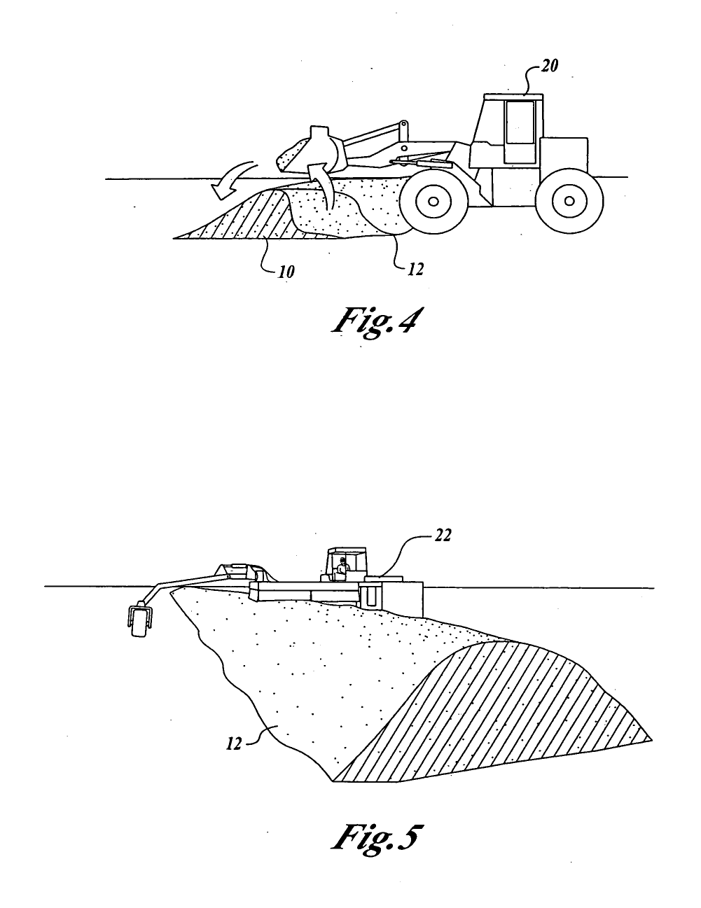

FIG. 3 illustrates the addition of moisture 16 to windrow 12 with the use of a water truck 18. Moisture 16 may simply be sprayed on the upper surface of windrow 12 and allowed to seep into manure 10. Further moisture distribution may be accomplished by mixing windrow 12 through the use of a tractor, mixer, or other equipment (See FIGS. 4 and 5). Note that fresh water may be used to add moisture. Alternatively, other sources such as run-off retention pond effluent may be used. Such effluent use returns nutrients to the composting manure.

The addition of moisture is preferably carried out simultaneously with mixing the waste by using a mixer 22 as illustrated in FIG. 5. Mixer 22 includes a water tank either incorporated in mixer 22 or pulled behind as a trailer. If moisture is needed, mixer 22 sprays moisture into windrow 12 as it is mixed. Mixer 22 may be a self-propelled compost mixer or a mixer pulled behind a tractor or other equipment.

After the initial moisture level is set, moisture levels are preferably checked at least weekly.

Besides monitoring moisture, temperature and oxygen levels are also preferably monitored. Temperature levels are preferably monitored at least every other day while oxygen monitoring may be performed less often depending on the equipment available. Alternatively, daily monitoring of temperature and moisture, or any other parameter, may be carried out.

As illustrated in FIG. 1, the basic preferred process of the invention includes the step of monitoring for a temperature drop after the initial moisture level is created and the manure is mixed. A significant temperature drop would be seen as daily monitoring shows a significant downward trend in the temperature (See FIG. 6). Typically, the average temperature of the windrow would be above 100° F. with an average of about 120° F. Maximum temperatures may be about 180° F. Thus, when a sustained significant drop below the previous temperature is seen through monitoring, the moisture is checked and added if needed and the windrow is mixed (either after moisture addition or simultaneously therewith). As long as the temperature climbs or continues to stay sufficiently elevated, no additional turning or moisture addition is needed and the process simply involves waiting. Note that the moisture is preferably monitored at least weekly. Thus checking the moisture may simply involve referring to the previous results, or may involve assessing another sample.

As mentioned, and as seen in the flowchart of FIG. 1 and the graph of FIG. 6, once a significant temperature drop is sensed, the moisture level is also checked and moisture added as needed. The moisture may be sampled again, or previous moisture test records may be reviewed to determine the approximate moisture content of the organic matter in the windrow. Whether or not moisture is needed, the windrow is mixed by turning the windrow with the loader or mixing the windrow with mixer 22 or other equipment (FIGS. 4 and 5). As discussed above, if a moisture amendment is needed, the moisture is preferably added simultaneously with the mixing by using mixer 22. Mixing, whether carried out with an addition of moisture or not, allows oxygen to be redistributed and introduced into the windrow. It also more evenly redistributes the moisture in the windrow and introduces additional oxygen into the manure.

The continuance of composting is noted by a temperature increase. As seen in the flowchart (FIG. 1), if the temperature increases, then the waiting stage is entered again to wait for the temperature drop and repeat the process. If a significant temperature increase does not occur after proper moisture is maintained and the windrow is mixed, then it is evident that the composting is nearly complete and the windrow simply needs to be cured by waiting and mixing. Preferably, such curing is accomplished by turning and/or mixing the windrow two weeks after the previous steps were completed with little or no increase in temperature. The windrow is mixed or turned again preferably after another two weeks, after which representative samples from the compost are taken. The samples are analyzed for fecal coliform pathogens, viable weed seed presence, maturity, stability, nutrient content, and other physical characteristics to ensure that proper composting and curing have occurred. Once the sample analyses results confirm proper levels of nutrients and other characteristics as noted, the composted manure is ready for shipment and packaging. The curing steps outlined above also help reduce the moisture content of the compost such that shipping is easier with a lighter weight soil enhancement product.

The process is also graphically illustrated in FIG. 6. The graph shows the results of temperature monitoring of one windrow in an actual field test according the process of the present invention. The time increments noted are ten days each. The trial was conducted at three confined animal feeding operations in central and western Kansas (“Feedlots A, B, and C). All three operations are beef feedlots, ranging in size from approximately 25,000 to 68,000 head capacity. At each location, the composting was done outdoors on a compacted soil base and all runoff was contained in a storage pond.

Two windrows were formed at each feedlot. Each windrow was a minimum of 300 feet long, 8 feet wide, and 3 feet high. Windrow #1 was comprised solely of manure, and Windrow #2 was comprised of manure and straw mixed together. The lack of sufficient moisture in some of the windrows required that moisture be added to create a suitable environment for composting. Feedlot A used both fresh water and run-off holding pond effluent, but primarily effluent, to increase the moisture content. Feedlot B used only fresh water. Feedlot C used only effluent until pathogen kill was achieved and then used only fresh water.

All windrows were monitored for temperature and oxygen content every other day. Moisture content was determined weekly. Temperatures were measured using a 48 inch stem, ReoTemp thermometer. The oxygen content was measured using a Bacharach Oxor II O₂Single Gas Analyzer, with a modified probe. The moisture content was determined by taking three discrete core samples from approximately equidistant locations in each windrow. One hundred grams of each sample was then dried in a microwave. The moisture content from each sample was determined by dividing the dry weight by the wet weight. The three samples from each windrow were then averaged, and that average was used to represent the moisture content of the windrow. Weather information including maximum temperature, minimum temperature, and precipitation were recorded daily at each feedlot. Where available, other weather information was also gathered. Variations in the presence of odor and pests were recorded. All staff time and equipment usage time was recorded, as well as any material costs.

The compost was analyzed for macronutrient content, secondary and micronutrient content, electrical conductivity, pH, percent moisture, percent organic matter, percent ash, bulk density, and carbon-to-nitrogen ratio. These analyses were completed three times throughout the process. The first analysis was performed immediately after the windrow was built, the second analysis was performed approximately three months after the windrow was built and the third analysis was completed after the windrow had cured for at least 30 days. The finished compost was also analyzed for the presence of viable weed seeds, CO₂ respiration, volatile NH₃, phytotoxicity, seedling growth response, and fecal coliform bacteria.

The windrows were turned frequently during the composting process, based on the core temperature of the compost. If the temperature decreased significantly from previous levels, the windrows were turned. This decrease in temperature is an indication that windrow conditions have become less favorable for microbial activity. Turning is an attempt to improve the microbial environment by redistributing the different particle sizes to increase passive air infiltration, and by redistributing the moisture. If the temperature increased or stayed somewhat constant, no action was taken. Occasionally, the windrows were turned more than once during a day, in an effort to add or distribute water, or increase the uniformity of the mix. Each feedlot used different equipment to build and turn the windrows. Feedlot A used a manure spreading truck to build both windrows. The manure spreading truck was also used to break up the straw bales, and mix the straw and manure for Windrow #2. A front-end loader was used to turn both windrows throughout the composting process. Feedlot B used dump-bed manure hauling trucks to build Windrow #1 and haul the manure for Windrow #2. A PTO-driven bale grinder was used to grind up the straw bales and apply the straw to the manure for Windrow #2. A Brown Bear 400 was used to mix the manure and straw together for Windrow #2, and turn both windrows throughout the composting process. Feedlot C used dump-bed semi-trucks to build Windrow #1 and haul the manure for Windrow #2. Front-end loaders were used to place the straw bales in Windrow #2. A front-end loader with a Wildcat turner mounted on the front was used to break up the straw bales and mix the straw and manure together. It was also used to turn both windrows throughout the composting process.

The equipment used to add water and/or storage pond effluent to the windrows varied also. Feedlot A used a 3,000-gallon water truck with a hose to spray water/effluent on the windrows while they were being built, and to pour effluent over the top of the windrows after they were built. Feedlot B used a 4,000-gallon water truck with a side discharge to spray water on the windrows while they were being built and after they were built. Feedlot C used a 2,500-gallon tank that was pulled behind the loader and mixer, and was connected to the mixer. This setup allowed water/effluent to be added while mixing. A 5,000-gallon water truck was also utilized to bring water/effluent to the pull-behind tank.

Referring to the particular windrow that generated the temperature conditions illustrated in FIG. 6, the formation of the windrows and initial moisture application and mixture occur at time increment 0. As seen the temperature increases after windrow formation with proper moisture levels. The temperature rise is indicative of microbial activity in the composting process. The temperature is monitored regularly and rises, in this case to over 140 degrees, within a few days. The temperature then begins to decrease. Before decreasing to ambient temperature (a state of no composting Microbial activity), the moisture level is checked and confirmed to be within an acceptable range. The windrow is then mixed. The mixing allows the moisture to be more evenly distributed and allows oxygen to infiltrate throughout the composting manure. An increase in temperature results. At times an initial small decrease in temperature occurred due to heat loss as the compost is mixed. Other small downturns may be due to external factors such as rainfall or cooler weather.

The monitoring process continues with sustained downturns in temperature triggering a need to turn or add moisture and turned (mix) the windrow. Finally, as can be seen from the results of the moisture addition and turning at time period 110 and the turning performed between time intervals 120 and 130, the compost has nearly completed active composting. The compost is then cured by waiting and turning. This curing has the benefit of drying the compost for a lighter weight soil enhancement product. Samples are taken for analyses and the product is removed, packaged, and shipped.

Composting manure, according to the process of the present invention, keeps the microbial environment favorable for efficient composting. The favorable conditions result from turning and mixing the windrow only when the temperature indicates that it is necessary and not simply based on a calendar schedule. Also, by not turning the windrow any more than necessary, the labor and equipment costs are kept low. The system does require additional monitoring of temperature and possibly moisture and oxygen relative to prior-art methods. However, these steps are relatively quick and easy and do not require expensive equipment and fuel. Thus, the savings of equipment and fuel in the reduced turning schedule should more than offset the additional monitoring necessary. The composting carried out according to the method described above creates a more physically uniform product, which should allow it to be applied more evenly and make it easier to handle. The odor, fecal coliform bacteria, and viable weed seeds are drastically reduced. Wet manure is dried during the process, resulting in a lower bulk density. This makes it much cheaper to transport, and can result in less field compaction as a spreading truck full of wet manure will weigh considerably more than a spreading truck full of dry compost. The product is more user friendly and more advantageous to crop producers. Another important characteristic of the compost is its soil enhancing capabilities. The organic matter contained in the compost will improve soil structure, enhance microbial activity, improve available water-holding capacity, and provide many other soil benefits, especially for abused, weathered, or other poor quality soils. This is particularly significant near urban areas where odor can dissuade people from using manure to build the soil quality.

Economic benefits can likely be gained from the increased concentration of phosphorous in the compost created according to the present invention as compared to the original manure. The higher phosphorous concentration allows compost users to apply less product, but receive the same amount of phosphorous fertilization. In essence, less compost needs to be transported and applied, and thus handling and transportation costs may decrease. The small amount of phosphorous that is lost from the windrow during the composting process may be captured in the effluent run-off storage pond and can be recycled as water for increasing the moisture of the compost piles or for direct crop use.

Composting, according to the process of the present invention, allows feedlot a workable option for operations wishing to decrease the volume and weight of manure that must be removed from the facility. The process also allows for the elimination of carbon amendments such as straw to the cattle manure. Although the addition of straw may slightly increase the speed of the composting process and can help decrease nitrogen losses, it is not necessary to the process. The addition of straw increases the overall moisture loss and the speed of the moisture loss, necessitating more moisture additions. It also bulks up the material, thus requiring more space to compost the manure.

While the preferred embodiments of the invention have been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A method of composting animal waste comprising the steps of:
(a) forming a pile of waste in an outdoor environment;
(b) monitoring the temperature of the pile;
(c) monitoring the moisture content of the pile;
(d) mixing the pile after a predetermined temperature drop;
(e) adding moisture to the pile to maintain the moisture content of the pile within a predetermined moisture range; and
(f) repeating the steps of monitoring the temperature and moisture, adding moisture, and mixing until such steps do not create a significant temperature increase following the step of mixing.

2. The method of claim 1, further comprising the step of bringing the pile to a predetermined moisture level and mixing the pile after the step of forming the pile and before the step of monitoring the temperature of the pile.

3. The method of claim 2, further comprising the step of curing and mixing the pile after prior steps do not create a significant temperature increase.

4. The method of claim 3, further comprising the step of analyzing samples of the pile to determine pile nutrient, moisture, and weed seed content.

5. The method of claim 2, wherein the pile includes organic matter and wherein the step of bringing the pile to predetermined moisture level comprises bringing the moisture content of the organic material portion of the pile within the range of 40 tog 65 percent moisture, on a weight basis.

6. The method of claim 1, further comprising the steps of curing and mixing the pile after prior steps do not create a significant temperature increase.

7. The method of claim 1, wherein the waste includes beef cattle manure.

8. The method of claim 7, wherein the waste includes beef cattle carcasses.

9. The method of claim 1, wherein the pile is formed into at least one windrow.

10. The method of claim 9, wherein the initial height and width of the windrow is at least three feet high and eight feet wide.

11. The method of claim 10, wherein the step of mixing is accomplished with a mixer.

12. The method of claim 1, wherein a significant carbon amendment is not added to the pile.

13. The method of claim 1, wherein added moisture is obtained at least partially from pile effluent.

14. The method of claim 1, wherein the temperature is monitored at least every other day.

15. The method of claim 14, further comprising the step of monitoring the oxygen level.

16. The method of claim 1, wherein the step of adding moisture to the pile includes bringing the moisture content of the pile within a range from 40 to 65 percent on a weight basis.

17. A soil enhancement produced by a process including:
(a) collecting cattle waste;
(b) forming the cattle waste into at least one pile;
(c) bringing the moisture level of the pile within a predetermined range;
(d) monitoring the temperature of the pile;
(e) mixing the pile upon a predetermined temperature drop of the pile; and
(f) repeating the steps of monitoring and mixing until mixing results in no significant temperature increase.

18. The soil enhancement of claim 17, wherein the process further includes the step of checking the moisture content of the pile after a predetermined temperature drop and adding moisture to the pile as needed to bring the moisture content within a predetermined range.

19. The soil enhancement of claim 18, wherein the cattle waste includes organic matter and wherein the predetermined range of moisture content is between 40 and 65 percent of the organic matter portion of the waste.

20. The soil enhancement of claim 18, wherein the process further comprises the step of curing the waste after mixing results in no significant temperature increase.

21. The soil enhancement of claim 18, wherein the pile is formed into an outdoor windrow.

22. The soil enhancement of claim 18, wherein a significant carbon amendment is not added to the pile.

23. A method of composting cattle waste comprising the steps of:
(a) forming a windrow of beef cattle manure including organic matter in an outdoor environment;
(b) bringing the moisture content of the organic matter in the windrow within a range of 40 to 65 percent;
(c) monitoring the temperature of the windrow;
(d) adding moisture as needed to bring the moisture content of the organic matter in the windrow to within the range of 40 to 65 percent and mixing the windrow after a predetermined temperature drop;
(e) repeating the steps of monitoring the temperature, adding moisture, and mixing until such steps do not create a predetermined significant temperature increase following the step of mixing; and
(f) curing the manure.
